(19) United States
(12) Patent Application Publication
(10) Pub. No.: US 2017/0129740 A1
(43) Pub. Date: May 11, 2017

(54) ELEVATOR SYSTEM

(71) Applicant: Inventio AG, Hergiswil (CH)

(72) Inventor: Vinay KUMAR, Pune (IN)

(21) Appl. No.: 15/129,957

(22) PCT Filed: May 16, 2015
(86) PCT No.: PCT/EP2015/055409

§ 371 Date: Sep. 28, 2016

(30) Foreign Application Priority Data
Mar. 28, 2014 (EP) 14162418.9

(51) Int. Cl. B66B 3/00; B66B 1/34; B66B 5/00

(52) U.S. Cl. CPC B66B 3/002; B66B 5/0012; B66B 1/3484; B66B 1/3407; B66B 2201/4623; B66B 2201/463

(57) ABSTRACT

An elevator control system prompts a person using the elevator to select a floor if they forget to do so after entering the elevator. The elevator control system detects the presence of a person in an elevator car, counts the time that passes starting from when the person is detected, and issues an alert when the time counted exceeds a given threshold and a floor call button has not been pressed within that time.

### FIELD

The present disclosure relates to an elevator system and in particular to an elevator system with improved user functionality.

### BACKGROUND

Sometimes when a person enters an elevator they forget to press the floor call button, which is necessary in order for the elevator to actually move to its intended destination floor.

This can be because people are very busy during their day to day lives due to economic and social pressures. Furthermore, the increasing use of mobile devices such as smartphones or tablets for both work or personal use including e-mail and social networking means that people tend to be distracted or preoccupied as they go about their daily business.

People may also forget to press a floor call button if they have impaired cognitive faculties, for example if they suffer from dementia.

At present, if a user forgets to press a floor call button in an elevator, the elevator doors will close and the elevator will simply remain stationary. This causes a delay and therefore frustration and/or embarrassment for both the user who forgets to press the floor call button and for other users.

### SUMMARY

According to a first aspect of the present disclosure there is provided an elevator control system comprising:
detection means for detecting the presence of a person in an elevator car;
timing means arranged to count time that passes starting from when a person is detected by the detection means; and
prompt means arranged to issue an alert when a time counted by the timing means exceeds a given threshold, if a floor call button has not been pressed within that time.

Optionally, the detection means comprises a load sensor.

Optionally, the detection means comprises an optical or infra-red sensor.

Optionally, the detection means comprises means for determining when an elevator door has opened and closed.

Optionally, the alert issued by the prompt means comprises an audible prompt.

Optionally, the audible prompt comprises a voice recording.

Optionally, the voice recording can be re-recorded when required.

Optionally, the alert issued by the prompt means comprises a visual prompt. The visual prompt may be displayed together with or in place of an audible prompt.

Optionally, the system comprises switch means arranged to selectively enable or disable the timing means and/or the prompt means.

Optionally, the timing means and/or the prompt means are/is switched off during peak times.

Optionally, the system comprises means to open an elevator door when the alert is issued.

According to a second aspect of the present disclosure there is provided a processor for use with an elevator control system comprising decision logic arranged to:
receive
   an input from a detection means for detecting the presence of a person in an elevator car,
   an input from a timing means arranged to count time that passes starting from when a person is detected by the detection means, and
   a floor call input;
and to provide an output for controlling a prompt means arranged to issue an alert;
wherein said decision logic sends an output to the prompt means to issue an alert when a time counted by the timing means exceeds a given threshold, if a floor call button has not been pressed within that time.

Optionally, the decision logic is arranged to receive an override signal which when asserted prevents an output being sent to the prompt means to issue an alert.

### DESCRIPTION OF THE DRAWINGS

The disclosure will now be described, by way of example only, with reference to the accompanying drawings in which:

FIG. 1 shows a conceptual overview of an elevator floor call reminder system according to an embodiment of the disclosure;

FIG. 2 shows a conceptual overview of a system design for the elevator floor call reminder system of FIG. 1;

FIG. 3 shows operation of an elevator according to the prior art; and

FIG. 4 shows the operation of an elevator using an elevator floor call reminder system according to an embodiment of the disclosure.

### DETAILED DESCRIPTION

An elevator system provides an elevator car (sometimes called a cabin) which ascends and descends within a hoistway. The elevator can stop at various calling points, usually referred to as floors. A person calls an elevator using an elevator call button and then when an elevator car arrives they enter the elevator and need to press a floor call button to indicate which floor they wish to travel to. The floor call button provides a signal that is registered with an elevator control system which controls an elevator mechanism to close the elevator doors, move the elevator along the hoistway to the desired floor, and then open the elevator doors. The elevator mechanism is commonly a rope driven by a pulley system, or a hydraulic piston.

The present disclosure provides an elevator control system comprising means to remind users to press the floor call button. In case a user forgets to press a floor call button, the control system of the present disclosure will remind the user to press a floor call button, with an audible alert, a visual alert or a combination of audio and visual alerts. The control system may also in alternative embodiments open the elevator doors.

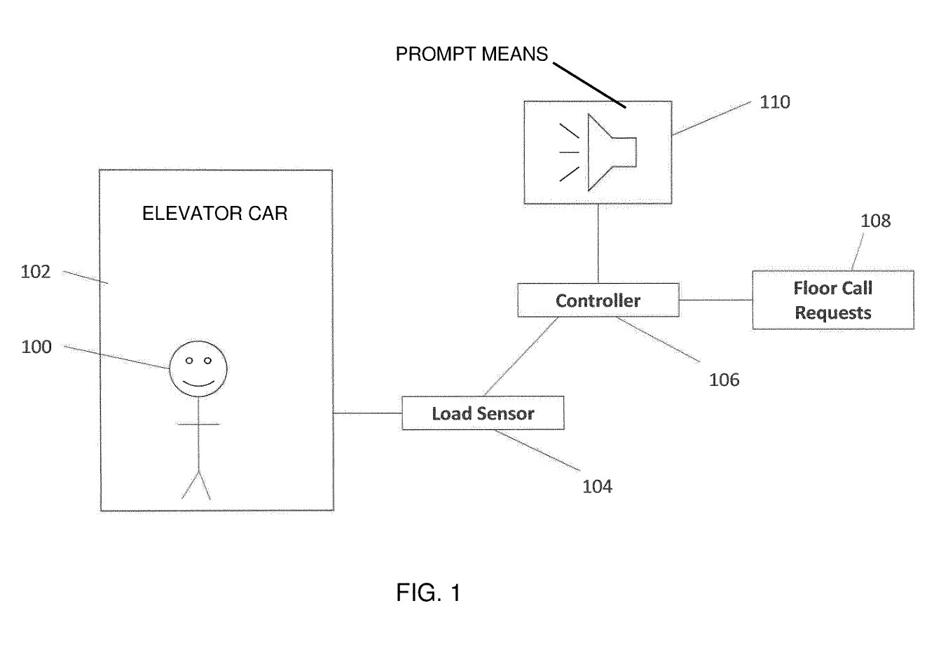

FIG. 1 shows a conceptual overview of the operation of an elevator control system according to a first embodiment. A person 100 enters an elevator car 102. When they enter the elevator car a detection means 104 senses their presence. The detection means 104 is in this embodiment a load sensor which detects when a weight above a given threshold is acting on the floor of the elevator car 102. In an alternative embodiment the detection means 104 may comprise an optical or an infra-red sensor. In a still further embodiment, the detection means 104 may simply monitor the opening and closing of the elevator doors, and consider there to be a person detected once the doors have opened and closed again.

A controller 106 may be provided which receives an input from the load sensor 104 and also receives an input when a floor call request is made, shown at 108. The controller 106 can send an output to a prompt means 110 which can issue an alert to a user. The prompt means 110 in this embodiment comprises a speaker which plays a tone, series of tones, a pre-recorded voice message, or any other suitable audible prompt. In alternative embodiments the prompt means 110 may comprise a visual prompt such as a light that is illuminated or a message that is presented on a display screen. A combination of audible and visual alerts may also be used.

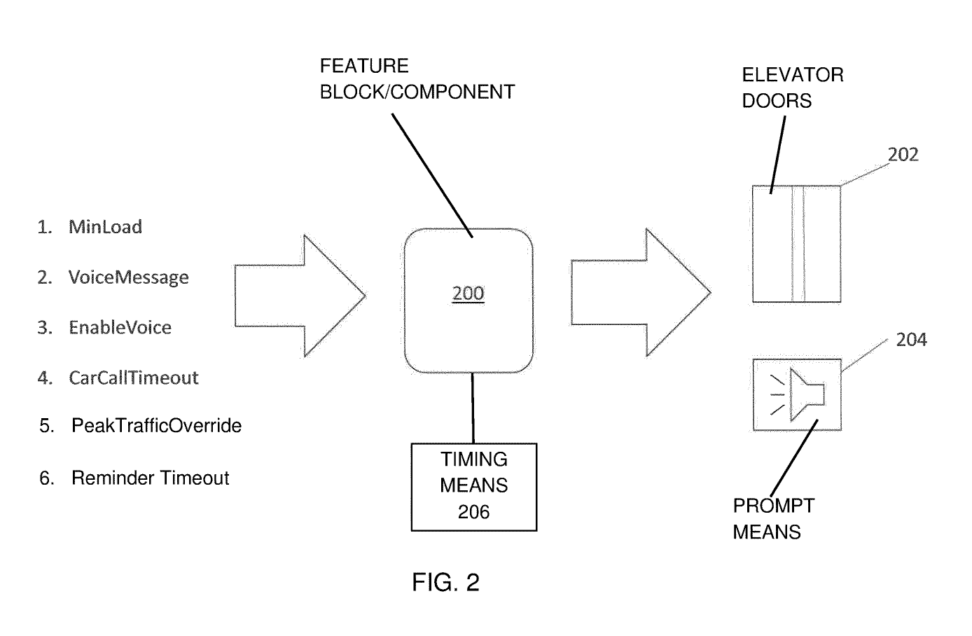

FIG. 2 shows a conceptual system design. Inputs (labelled 1 to 4) are provided to a feature block/component 200, which processes the inputs to provide outputs for controlling a prompt means 204 and optionally also for operating elevator doors 202. Said feature block/component 200 can be implemented as a functionality of the aforementioned controller 106.

The Input 1 parameter “MinLoad” here represents a minimum load that can be defined as a threshold for deciding that a person is present in the elevator car. The Input 2 “VoiceMessage” is a digital sound file that can be played back over a speaker system of the elevator. This message can be configured or re-recorded as desired. The Input 3 “EnableVoice” is a signal generated by a switch arranged to selectively enable or disable the timing means and/or the prompt means. The Input 4 “FloorCallTimeout” is a configurable value for a timing means 206 that defines a threshold for triggering an alert for the person in the elevator.

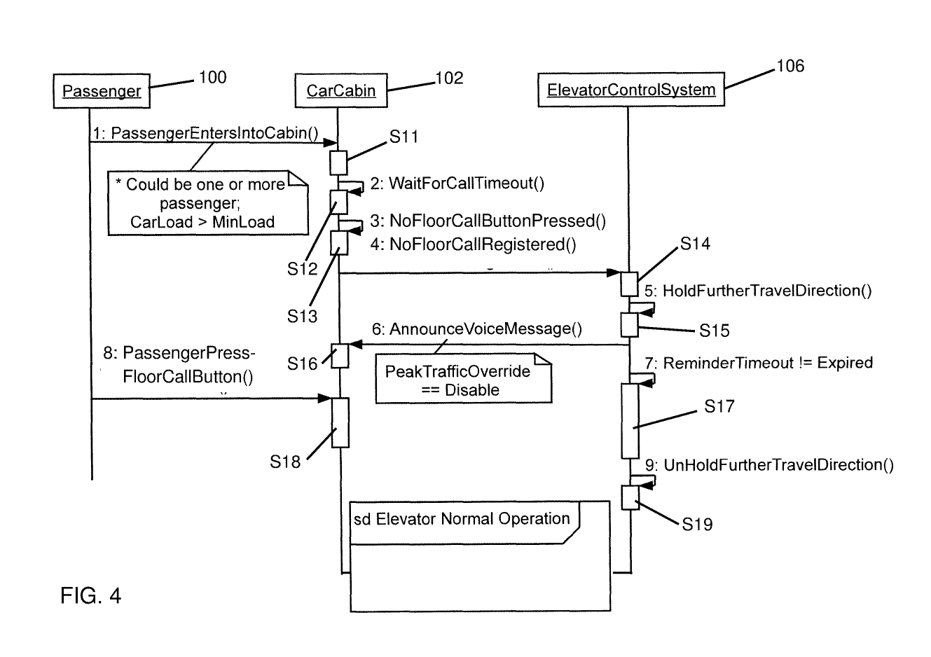

It is also possible to provide a “PeakTrafficOverride” signal (Input 5 FIG. 4), which can be used to selectively disable the reminder system, for example during peak times such as 8-9 am and 5-6 pm each Monday to Friday or other case-specific “rush hours”. A “ReminderTimeout” signal (Input 6) can also be defined, which holds the elevator car for a specific time before switching back to normal operation.

When there are groups of elevators in a building, the reminder system of the present disclosure can be implemented independently with each elevator without affecting other group functions.

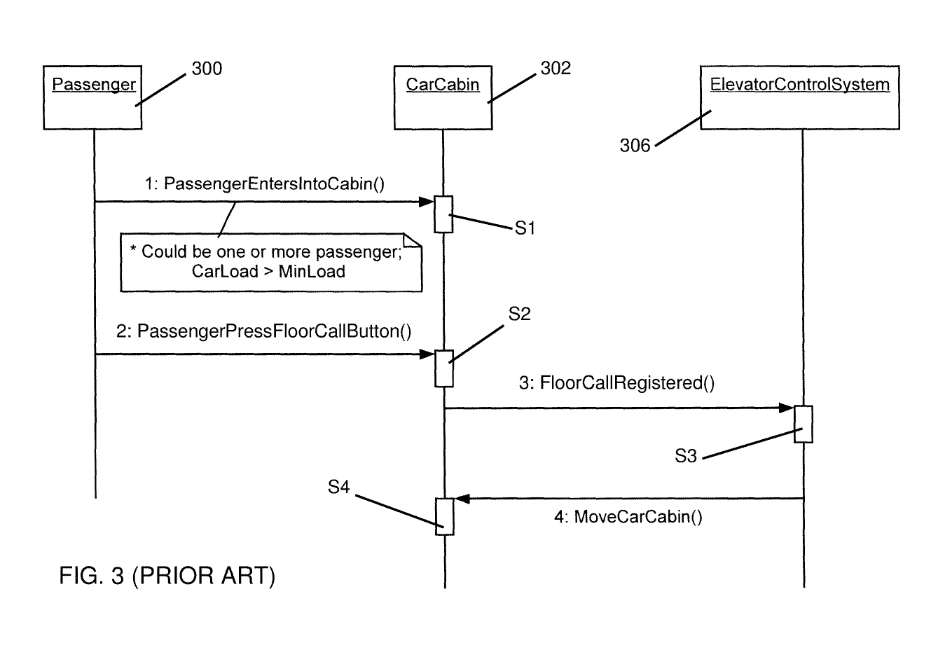

FIG. 3 shows a normal elevator operation. In a step S1 a passenger 300 enters the car 302. In a step S2 the passenger 300 presses the floor call button. In a step S3 the floor call is registered. In a step S4 the elevator control system 306 responds to the registered floor call by moving the car 302. As is shown in the figure, if the floor call button is not pressed, the elevator simply waits indefinitely.

FIG. 4 shows the operation of an elevator using an elevator floor call reminder system according to an embodiment of the disclosure. As shown in the figure, after a certain time threshold has been reached (timing means 206) following the detection of the presence of a user (detection means 104), the system 106 checks whether a floor call button has been pressed. The time is counted by the timing means 206 which can comprise a real-time clock, quartz crystal timer or any other suitable equivalent. As mentioned above, the presence of a person (or people) can be detected with the detection means 104, e.g. a load sensor, optical or infra-red sensor, or by monitoring the opening and closing of the elevator doors, and consider there to be a person detected once the doors have opened and closed again.

If a floor call button has not been pressed after the given time elapses, an alert (for example playback of a voice message) is activated by the prompt means 110 or 204 to prompt the person (or people) in the elevator.

The method of operation shown in FIG. 4 includes a step S11 for detecting when the passenger 100 enters the car 102. In a step S12 the elevator control system 106 waits for the timing period to time out. In a step S13 the system determines that no floor call button has been pressed by the passenger and consequently in a step S14 no floor call has been registered. The system 106 responds by holding the elevator from further travel in a step S15. In a step S16 the system 106 generates a reminder voice message (prompt) to the passenger 100 in the car 102. In a step S17, if the reminder time period expires, the elevator control system 106 performs a step S19 that releases the travel hold and normal operation of the elevator starts in a step sd. In a step S18 if the passenger 100 presses the floor call button the system will perform the steps S3 and S4 shown in FIG. 3 resulting in the step sd being performed.

Various improvements and modifications can be made to the above without departing from the scope of the disclosure.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. An elevator control system comprising:
a detection means for detecting a presence of a person in an elevator car controlled by the elevator control system;
a timing means arranged to count time that passes starting from when the person is detected by the detection means; and
a prompt means arranged to issue an alert when a time counted by the timing means exceeds a given threshold and a floor call button in the elevator car has not been pressed within that time.

15. The elevator control system according to claim 14 wherein the detection means comprises a load sensor.

16. The elevator control system according to claim 14 wherein the detection means comprises an optical sensor or an infra-red sensor.

17. The elevator control system according to claim 14 wherein the detection means comprises means for determining when an elevator door of the elevator car has opened and closed.

18. The elevator control system according to claim 14 wherein the alert issued by the prompt means comprises an audible prompt.

19. The elevator control system according to claim 18 wherein the audible prompt comprises a voice recording.

20. The elevator control system according to claim 19 wherein the voice recording can be re-recorded when required.

21. The elevator control system according to claim 14 wherein the alert issued by the prompt means comprises a visual prompt.

22. The elevator control system according to claim 14 comprising switch means arranged to selectively enable or disable at least one of the timing means and the prompt means.

23. The elevator control system according to claim 22 wherein at least one of the timing means and the prompt means is switched off during peak times of operation of the elevator car.

24. The elevator control system according to claim 14 comprising means to open an elevator door of the elevator car when the alert is issued.

25. A controller for use with an elevator control system comprising:
decision logic when executed by the controller being arranged to receive
an input from a detection means for detecting a presence of a person in an elevator car,
an input from a timing means arranged to count time that passes starting from when the person is detected by the detection means, and
a floor call input;
the decision logic providing an output for controlling a prompt means arranged to issue an alert; and
wherein the decision logic sends the output to the prompt means to issue an alert when a time counted by the timing means exceeds a given threshold and a floor call button has not been pressed within that time to send the floor call input.

26. The controller according to claim 25 wherein the decision logic is arranged to receive an override signal which when received prevents the output from being sent to the prompt means to issue the alert.
